(19) United States
(12) Patent Application Publication
(10) Pub. No.: US 2004/0192137 A1
(43) Pub. Date: Sep. 30, 2004

(54) Surface material

(76) Inventors: Martin James Starkey, Apse Heath (GB); Derek Simon Richard Ness, Ventnor (GB); John Lawrence Lambert Fowler, Portsmouth (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/716,377

(22) Filed: Nov. 18, 2003

Related U.S. Application Data
(63) Continuation of application No. PCT/GB02/02206, filed on May 22, 2002.

(30) Foreign Application Priority Data
May 23, 2001 (GB) 0112541.8

(51) Int. Cl. B32B 27/12

(52) U.S. Cl. 442/286; 442/394

(57) ABSTRACT

A surface material provides an in-mold surface coating of a high cosmetic quality and includes a layer of a surface resin material and a resin conducting layer. The resin conducting layer comprises a venting structure for venting intralaminar and interlaminar gases during processing of the surface material. The resin conducting layer further includes a resin retention structure for keeping the resin material in contact with the mold surface.

### CROSS REFERENCE TO RELATED APPLICATION

This application is a continuation of International Application No. PCT/GB02/02206, filed May 22, 2002, which claims priority from U.K. Patent Application No. 0112541.8, filed May 23, 2001. The disclosures of both applications are incorporated herein by reference.

### BACKGROUND OF THE INVENTION

The present invention relates to a surface material, particularly, but not exclusively, to a surface material suitable for providing a cosmetic quality surface on a composite laminate structure.

Molding materials comprising a reinforcement material and a resin material are widely used for the production of lightweight structural components. One of the problems associated with these moldings is that, for a lot of applications, it is not possible to cost effectively produce a molding with a high quality cosmetic surface directly in the mold. Therefore, additional surface treatments, such as fairing and coating, are necessary to arrive at the desired cosmetic surface quality. These problems are caused by various properties of the conventional molding materials.

In conventional molding materials, the ratio of the fibrous reinforcement material and the resin material is such that the cured molding material has optimal mechanical properties. Although this composition of the material is suitable for arriving at the desired mechanical properties, the cosmetic surface quality of the external surfaces of the moldings is not satisfactory. The fiber structure is visible on the surface of these moldings, which requires further surface treatment to arrive at the desired cosmetic quality finish. With an increase in temperature, the fiber structure can be even more visible. This effect is amplified by the structure of the reinforcement fabric, which is relatively coarse. Furthermore, the fibrous reinforcement material cannot retain the resin material onto or close to the surface of the mold. We believe that this is caused by the strong cohesion of the resin material in combination with poor wetting of the resin of the mold surface. These reduced wetting properties, or rather “de-wetting”, results in further surface defects on the cured molding in the form of voids and pinholes. Generally, the resin loading of the reinforcement material is not sufficiently high to arrive at an external molding surface with a high cosmetic quality.

Popular pre-formed or pre-fabricated molding materials, wherein the resin material impregnates the fibrous reinforcement material (commonly known as pre-pregs), have various additional disadvantages which prevent these materials from being suitable as an in mold cosmetic quality surface. A common problem associated with pre-preg materials is that due to the low permeability of pre-preg materials to interlaminar and intralaminar gases and air, gases and air can be trapped between the mold surface and pre-preg material, which results in voids and surface defects on the external surface of the molded article. These defects require the molded article to be further treated by fairing, sanding, and coating in order to arrive at the desired cosmetic quality surface. The surface defects can be reduced by the use of an autoclave, together with an increased consolidation pressure, which can force and trap air bubbles so that these are reduced in size. However, these measures cannot prevent voids from occurring at the surface during processing and curing of the material. Another drawback of this type of processing is that the process is generally expensive and complicated. Furthermore, the equipment limits the component size of the molded article.

Furthermore, conventional pre-preg materials have relatively poor mechanical properties, which are due to the impermeability of pre-preg materials to intralaminar and interlaminar gases during processing of the material. This results in voids in the cured laminate.

We have discovered that some of the surface quality problems associated with molding materials in general and pre-preg materials in particular are largely overcome by a molding material comprising a reinforcement resin material and a fibrous reinforcement material which comprises an air ventilating structure in the form of a dry or partially dry reinforcement layer, which allows interlaminar and intralaminar gases, such as air, to be released from the molding material during processing of the material. This molding material is disclosed in WO 00/27632 (Ness et al.), the disclosure of which is incorporated herein by reference. This material, when applied in a mold, has the advantage that entrapped air and interlaminar gases which are trapped between the mold surface and the molding material can be conveniently released via the reinforcement material layer. However, the other above-described surface problems remain, which result in a poor cosmetic surface quality. The low resin loading of the surface of the molding material further results in surface defects and a visible reinforcement material structure associated with the resin and reinforcement material properties. Furthermore, the above-described problems of de-wetting at the mold surface also occur.

As discussed above, for a lot of applications, it is not possible to produce a molding with a high-quality cosmetic surface directly in the mold (in-mold) using the above-described molding materials. High cosmetic quality surfaces are therefore achieved directly in the mold using in mold coatings (generally known as gel coats), which are applied in the mold as the first layer. Further layers of a molding material are usually located relative to the gel coat layer. A problem associated with these gel coats is the handling of these materials during their application in the mold. Generally, the application of a gel coat requires a high level of skill and experience from the fabricator in order to achieve a high quality cosmetic surface in the end product. Usually, the gel coat is applied directly into the female mold as a paste or coating. The gel coat is then gelled or tacked off at an approximate room temperature, and further layers of a molding material are applied. If the mold has a complex shape, the application of the gel coat is rather complicated, and it is difficult to achieve an even thickness of the gel coat. Not only is this process time-consuming and inefficient, but also, for a high quality cosmetic surface, it is important that the molding materials are laid up at the optimal state of tackiness of the gel coat. Further molding material layers are laid up onto the gel coat layer to form a laminate. This laminate is then processed and cured to form a molded article.

It is, therefore, desirable to provide an improved surface material, and a method of forming said improved surface material, which allows more efficient fabrication of molded articles with enhanced cosmetic quality surfaces and enhanced surface properties, thereby addressing the above-described problems and/or which offer improvements generally.

### SUMMARY OF THE INVENTION

In embodiments of the present invention, there are provided a surface material, a laminate structure, and a method of forming a molded article as defined in the accompanying claims.

In an embodiment of the invention, there is provided a surface material adapted to provide an in-mold surface coating of a laminate structure comprising a layer of a surface resin material and a resin conducting layer, said resin conducting layer comprising a venting structure for venting gases during processing of said surface material, said resin conducting layer further comprising a resin retention structure for keeping said resin material into contact with the mold surface during processing of said surface material. The resin retention structure may be adapted to reduce the tendency for the formation of surface irregularities during processing. The gases may comprise gases, such as air, which are entrapped between the mold surface and the surface material, interlaminar gases (gases trapped between molding material layers), and intralaminar gases (gases trapped within layers of the molding material and surface material).

In this way, it is achieved that resin wets the complete mold surface and that the resin is into contact with the mold during processing of the material, whereby any entrapped air which may be located between the mold surface and the surface material can conveniently escape via the venting structure during processing of the surface material. The resin conducting layer is porous and permeable to any interlaminar and intralaminar gases and air so that these gases can escape via this layer.

The resin conducting layer has the further advantageous property that it allows complete wetting of the mold surface. Normally, due to the properties of the mold surface, the mold surface is resin repellant. This is necessary in order to avoid the molding from adhering to the mold, which would otherwise prevent release of the molded article from the mold. These particular properties of the mold surface have, however, the disadvantage that de-wetting of the resin at the mold surface occurs. The surface tension of the resin is relatively high. This prevents complete and permanent wetting of the tool surface.

We believe, although we do not wish to be bound by any theory, that in an embodiment of the invention, the surface material has a resin conducting layer which comprises suitable properties for retaining the resin onto the mold surface during processing of the material such that no de-wetting occurs. The resin is retained close to the surface due to the fine weave or the like structure of the material which absorbs and retains a high volume of surface resin material. This volume is higher than the volume of the resin material which is usually retained in conventional molding materials on or near the mold surface. The high surface resin loading prevents de-wetting of the mold surface. The resin retention structure may have a fine weave or the like structure, whereby the resin retention structure is adapted to reduce the tendency for the formation of surface irregularities.

In a preferred embodiment of the invention, the resin retention structure is in contact with the mold surface prior to processing of said surface material. During processing, the air inside the resin conducting layer and the air trapped between the surface material and the mold surface escapes. The surface resin material simultaneously advances through the surface material towards the mold surface to wet out the surface fabric. This ensures complete wetting of the mold surface and results in a cured molding with a high cosmetic quality surface finish. Processing of the material may further require a vacuum pressure.

The resin conducting layer may further comprise a fabric material. This fabric material may comprise a lightweight woven fibrous material. The properties of the fabric material are such that the resin material adheres to the fabric material when the matrix is formed. In particular, the adherence to the fabric material is best if a lightweight woven fibrous material is applied which has a fine weave structure. The lightweight fibrous structure “holds” the surface resin system in place during the cure and prevents reticulation on the release coated tool surface, which would otherwise cause defects in or on the cured surface.

The resin retention structure and the resin conducting layer may be identical so that the resin retention structure is formed by the resin conducting layer. The resin loading of the resin conducting layer is higher than the resin loading of the reinforcement layer of conventional molding materials (including air venting molding materials) as hereinbefore described. The surface material thus produces a high quality cosmetic surface finish. Further, the resin conducting layer comprises a lightweight fibrous material which is not suitable as a reinforcement material. The preferred weight of the fibrous material is generally between 10 g/m² and 200 g/m².

In a particular embodiment of the invention, the surface material may comprise a reinforcement layer. The reinforcement layer may comprise a woven and/or a non-woven fibrous reinforcement material. The reinforcement material can simply adhere to the surface resin material because it is inherently tacky. This enables uni-directional fibers to be applied as a suitable re-enforcement material without the need for any stitching to maintain the integrity of the uni-directional material during its production and handling. The uni-directional fibers are held by the tacky surface resin material.

In another embodiment of the invention, the reinforcement layer may comprise a reinforcement resin material. This reinforcement resin material may impregnate the reinforcement fibrous material or, alternatively, the fibrous reinforcement material may be located onto the reinforcement resin material, whereby the fibrous reinforcement material is dry or at least partially dry. This particular advantageous embodiment allows the venting of entrapped interlaminar and intralaminar gases via the reinforcement layer during processing of the laminate structure. This prevents voids from forming in the cured reinforcement layer of the laminate, which would otherwise affect the mechanical and structural properties of the cured laminate structure.

In another embodiment of the invention, the surface resin material may be located between the resin conducting layer and the reinforcement resin layer. In an embodiment, the reinforcement resin material may comprise high glass transition temperature properties, whereas the surface resin material may comprise low glass transition temperature properties. The glass transition temperature is the temperature above which the resin material becomes soft and pliable and below which it becomes hard and glassy. This difference in glass transition temperature allows the cured surface material to dissipate energy caused by the thermal stresses which may build up at elevated temperatures as a result of differing coefficients of thermal expansion in the cured surface material.

Apart from the difference in glass transition temperatures, there may be a difference in the viscosity profile of the surface resin material and reinforcement resin material. The principle behind combining resin materials with different resin viscosity properties for the surface resin material and the reinforcement resin material is as follows. During processing, as the temperature is increased in the surface material, the viscosity of the surface resin material may drop faster than the viscosity of the reinforcement resin with an increase in temperature. The minimum viscosity of the surface resin material is, however, higher than the minimum viscosity of the reinforcement resin material. The viscosity properties control the flow of the surface resin material into the resin conducting layer and, as the surface resin material reaches its flow point sooner at a lower temperature in comparison to the reinforcement resin material, the surface resin material has more time to wet out the resin conducting layer. Furthermore, since the minimum viscosity of the surface resin material is higher than the minimum viscosity of the reinforcement resin material, the surface resin material is prevented from flowing away from the mold surface, and the reinforcement resin is prevented from inter-mixing or even emerging on the mold surface.

Additives in both the reinforcement resin material and the surface resin material may improve the flow properties and the toughness of the resin materials. The controlled flow of the surface resin material acts as a barrier, preventing the reinforcement resin from being drawn into the resin conducting layer.

In another embodiment of the invention, the surface resin material and the reinforcement resin material may comprise such thermal expansion properties that thermal stresses which are built up at elevated temperatures as a result of differing coefficients of thermal expansion in the cured surface material, are dissipated. This prevents interfacial stresses from occurring between the surface layer formed by the surface resin layer and the resin conducting layer and the reinforcement layer, which can result in deformation of the cured surface and impair the surface profile.

Stresses can also result from a difference in the elastic modulus of the surface layer and the reinforcement layer. Particularly, if a polyester gel coat resin material is applied as the surface resin material in conjunction with an epoxy reinforcement resin material, such interfacial stresses are likely to occur since the surface layer comprises a relatively high elasticity modulus, whereas the reinforcement layer comprises a relatively low elasticity modulus.

In a further embodiment of the invention, the surface resin material and/or reinforcement resin material may be non-homogenous. This can be achieved by combined layers of resins which form the surface resin material. The non-homogenous surface resin material has the advantage that the elasticity modulus and other mechanical properties may be tailored to a specific application of the surface material. More in particular, the mechanical properties of the surface material may be adapted to the properties of the laminate stack onto which the surface material is provided so as to avoid interfacial stresses between the laminate stack and the surface material, which can result in preliminary mechanical failure of the structure and delamination.

In another embodiment of the invention, the surface resin material may comprise a thermo-set resin material and/or a thermo-plastic resin material. Generally, thermo-plastic resin materials are more suitable for recycling purposes. This is particularly advantageous in automotive applications of the surface material, where recycling of body panels and other parts is an important issue.

In an embodiment of the invention, the surface resin material may comprise additives, said additives comprising filler components and/or pigment components and/or toughened components and/or filter components or combinations of the aforesaid components. The filler components may comprise filler components which allow the surface material to be more easily sanded. Suitable filler components are talc, silicon carbide and other components. The filler components may also contribute to the surface of the mold being highly abrasive. The pigment components may comprise dye stuffs or other suitable pigments for coloring the surface material layer. Suitable pigment components may comprise carbon black particles, titanium dioxide, or any other suitable dye stuffs. The toughener components may aid in adapting the elasticity modulus of the surface material to the elasticity modulus of the reinforcement molding materials so that interfacial stresses are less likely to occur between the surface material layer and the laminate stack. Filter components may comprise components which aid in preventing weathering of the surface material layer, such as UV filters components (for example glass particles) and water repellant components to further improve weatherability of the surface material.

The surface material may comprise a surface resin material, said surface resin material comprising a gel coat resin material. In this advantageous embodiment of the invention, a gel coat is applied in a pre-formed and/or pre-fabricated form (i.e. as a preform material) and preferably supplied on a roll by the supplier to the manufacturer of moldings. The pre-form surface material may be cooled during storage and transport to prevent curing of the surface material prior to its application in the mold. Upon its application by the fabricator, the material is rolled out into the mold and cut to the desired length. Subsequently, the further molding material layers are applied onto the surface material layer to form a laminate, and the laminate is processed. During processing, as discussed above, any entrapped air or entrapped interlaminar and intralaminar gases which may be trapped between the mold surface and surface material layer and/or between intermediate laminate layers can conveniently escape via the venting structures which are provided in the surface material. This results in a void free cured laminate molding with a high cosmetic quality surface finish and excellent mechanical properties due to the absence of voids in the laminate.

In an embodiment of the invention, the surface material may comprise a layer of surface resin material sandwiched between a layer of resin conducting layer and a reinforcement layer. The resin conducting layer and the reinforcement layer may be unimpregnated or partially impregnated with the surface resin material. The surface material may thus be dry to touch on the external surfaces and may thus be conveniently supplied on a roll and handled by the fabricator.

In an alternative embodiment, the surface material may comprise a resin conducting layer and a surface resin layer. The resin conducting layer may be dry or partially dry (unimpregnated). In order to supply the preformed surface material on a roll, the surface material may be provided with a backing layer to prevent the material from adhering to itself on a roll and during handling. The backing layer may be provided on the external surface of the surface resin layer. The backing layer may comprise a backing paper, preferably a silicon coated backing paper.

In another embodiment of the invention, the surface material may comprise a resin conducting layer, and the resin conducting layer may be adapted to move through the surface resin material during processing of the surface material. Before the surface material is processed, the surface resin layer may be in direct contact with the mold surface, and the resin conducting layer may be provided on the surface resin layer. The surface resin material may thus separate the resin conducting layer from the mold surface prior to processing of said surface material. Upon processing, the resin conducting layer may be moved or forced through the surface resin material to provide a path for gases to escape and to retain the surface resin onto the mold surface. The thickness of the resin conducting layer may be larger than the thickness of the surface resin layer so that the resin conducting layer is moved through the surface resin layer by the pressure which is applied onto the surface material when processing takes place. The pressure may be applied by a mold, by vacuum processing (vacuum bagging), autoclave, or any other suitable means. The resin conducting layer preferably comprises a fibrous material which is sufficiently resilient to withstand the pressures of (pre-)processing.

In yet another embodiment of the invention, the surface material may comprise a layer of a surface resin material and a resin conducting layer as hereinbefore described. The resin conducting layer may comprise a venting structure for venting gases during processing of the surface material. The resin conducting layer may provide a resin retention structure for retaining said surface resin material in contact with the mold surface during processing of said surface material. The material may further comprise a further resin conducting layer, the further resin conducting layer comprising a venting structure for venting gases during processing of the material, the further resin conducting layer being adapted to move through the surface resin layer during processing of the surface material. In this way, the gases are vented through the surface resin layer, while the first resin conducting layer retains the resin on the mold surface and prevents surface irregularities. In another embodiment, the resin conducting layer may not comprise a venting structure, and the resin conducting layer solely functions as a resin retention structure.

In a further embodiment, there is provided a surface material comprising a layer of a surface resin material and a resin conducting layer. Further, there is provided a laminated structure comprising a layer of a molding material and a layer of a surface material as hereinbefore described.

In another embodiment, there is provided a method of forming a molding comprising the steps of providing a surface material as hereinbefore described in relation to a mold surface such that the resin retention structure is in contact with the mold surface, and providing one or more layers of a molding material in relation to said surface material to form a laminate structure, said method further comprising the steps of processing said laminate structure to form said molding.

In another embodiment of the invention, there is provided a method of forming a surface material as hereinbefore described comprising the steps of providing a layer of a resin conducting material for keeping a surface resin material in contact with a mold surface, and providing a layer of a surface resin material onto said resin conducting layer to form said surface material. The method may comprise the step of locating a reinforcement resin material in relation to said surface resin material. The method may further comprise the steps of providing a layer of a fibrous reinforcement material onto said surface material, and said method may comprise the step of locating said reinforcement material in relation to said reinforcement resin material. According to another embodiment of the invention, there is provided a method for providing a surface finish onto a laminate structure comprising the steps of providing a surface material as hereinbefore described onto said laminate structure, and curing said laminate structure.

In yet another embodiment, there is provided a method of forming a molded article comprising the steps of providing a surface material as herein before described in relation to a mold surface, and providing one or more layers of a molding material in relation to said surface material to form a laminate structure. The method may further comprise the steps of processing the laminate structure to form the molded article. In a preferred embodiment, the molded article is processed in two stages, the first stage comprising the step of moving the resin conducting layer through the surface resin material, and the second stage comprising the step of processing the laminate structure.

In another embodiment, the first stage may comprise the step of applying pressure to the laminate structure, and the second stage may comprise the step of increasing the temperature of the laminate structure to allow the resin to flow. The first and the second processing stages may be conducted simultaneously.

There is thus provided a surface material, a laminate structure, a method of forming a molding, a method of forming a surface material, and a method of providing a surface finish according to the embodiments of the invention.

Many applications of composite materials require a high quality cosmetic finish on the final cured molding or molded article. Since the surface quality of traditional molding material, such as pre-preg materials, is inadequate for achieving such a high quality surface finish, molded articles are usually given a paint finish as part of its manufacture. In order to achieve a high quality paint finish, the component must have a smooth finish, free of voids and other surface defects, and be capable of being easily keyed to accept a paint coat. Generally, moldings based on conventional molding materials, such as pre-pregs, do not have such properties. Due to the low permeability of pre-preg materials, there is a tendency for them to trap air between layers of the pre-preg material and between the surface of the mold and the pre-preg material. The resulting surface of the cured part then contains defects.

Although these defects can be partially reduced with the use of an autoclave (which, by increasing the consolidation pressure, can force and trap air bubbles to reduce in size, thereby creating a lower void content), there are inherent problems to the use of an autoclave. Not only does the use of such a device add significantly to the overall production costs of moldings, but also, due to the inherent size of most moldings, such as yacht hulls, wind turbine blades, and other constructions, there are limits to the size of structure which can be cured in this way.

The present invention relates to a surface material which in itself can result in a high quality cosmetic surface finish on the exterior of the molding or can be tailored such that the surface molding has a high quality surface which is particularly suited to the application of a coating, and whereby fairing of this surface is relatively easy due to the addition of additives to the surface resin material. Such additives may comprise talc, silicone carbide and other suitable fillers.

Alternatively, as discussed previously, the surface material in itself may be sufficient to arrive at a high quality surface finish, which obviates the need for an additional surface coating. For some applications, a gel coat resin material may be used as a suitable surface resin material.

In a preferred embodiment, the surface material comprises a surface resin material and a resin conducting layer for conducting the resin close to the surface of the mold, said resin conducting layer further comprising a resin retaining structure for retaining the surface resin material close at or on the mold surface. The resin conduction is achieved by the resin conducting layer because of its unimpregnated form, which prevents laminar gases from being trapped between the mold surface and the surface material. The surface layer further comprises a resin retention structure, which allows the resin to be held in close contact with the mold surface. This resin retention structure has such properties that de-wetting at the mold surface cannot occur. The structure of the resin conducting layer is such that it can absorb a large volume of the resin and can retain it close to the mold surface, which results in better wetting of the mold surface. The resin conducting layer thus has a relatively high resin loading.

The surface material is applied against the mold surface and, after curing, it results in a defect free component surface without the need for excessive vacuum consolidation pressures during processing and curing of the material. The surface resin material may comprise a thermo-set or a thermoplastic resin film. The surface resin may also comprise a gel coat. The surface material may further comprise a lightweight reinforcement material which is in contact with the surface resin material on the rear face of the surface resin material which located furthest from the tool or mold surface.

In another embodiment, a relatively thick, perhaps random-lay, fiber material is used behind the surface resin layer as an alternative resin conducting layer. This fiber material is thick and resilient enough to withstand the application of vacuum at ambient temperature and be pushed or moved through the thick surface resin layer to provide an air-breathe route in a direction approximately perpendicular to the mold surface and the surface material layer (Z direction) to remove trapped air from between the mold and the surface resin layer. During processing, at a later stage, as the temperature is raised, the surface resin viscosity drops, and the resin flows to give a smooth cosmetic quality surface and to fill the fibrous resin conducting layer from both sides. An important aspect here is the need to avoid the print-through typically associated with a woven fabric. The fabric is avoided to be visible through the surface resin material by the application of unwoven fabrics and/or lightweight fabrics. Particularly suited in this respect are needle felts. Also suitable is “pre-ox PAN”. This is a partially oxidized polyacrylonitrile fibrous material (the precursor to carbon fiber), which is normally used as a mat for fire-proofing and sound deadening in under-bonnet automotive applications.

A suitable resin conducting layer material is a needle felt material with a thickness greater than that of the resin film. Under ambient temperature and vacuum pressure, the felt is forced through the high viscosity resin film, providing a path for the air to be removed through the film thickness. This can be done as an additional step as part of processing. In yet another embodiment, there is provided a molding material comprising a resin conducting layer sandwiched between layers of a surface resin material as hereinbefore described or an alternative surface material comprising a surface resin material layer. The resin conducting layer may comprise a venting structure for venting gases during processing of said molding material, the resin conducting layer further providing a resin retention structure for retaining said surface resin material in contact with the mold surface during processing of said molding material, the resin conducting layer being adapted to move through the surface resin material during processing of the molding material. This material provides a molding which comprises two-sided cosmetic quality surfaces and which may be processed in one single stage. The material may comprise a further resin conducting layer. The further resin conducting layer may comprise a resin retention structure. The resin conducting layer may be provided on the external surface of the surface resin material. This also greatly improves handling of the material, as the external surfaces are dry and, therefore, easy to handle. The mold material may be manufactured by using two lightweight surface resin films with felt in between. The felt forms the resin conducting layer. A surface carrier or lightweight scrim may further be applied on the external surface of the surface resin film.

One or more further layers of a molding material, such as, for instance, a conventional pre-preg molding material, may be stacked onto the surface material layer. The surface material co-cures together with the stacked molding materials so that a defect free surface is achieved on the cured molded article. The resin conducting layer may be dry or semi-impregnated by the surface resin material. In another embodiment of the invention, a second lightweight reinforcement layer is provided on the rear face of the surface resin film to arrive at a breathable layer for venting interlaminar and intralaminar gases, which may be trapped between the surface layer and the molding layers of the laminate structure. Typically, the resin conducting layer comprises a woven or non-woven fabric, such as a glass fibrous material, a carbon fibrous material, aramid fibrous materials, or a thermo-plastic material, such as a polyester material or a nylon fabric material. The weight ranges for the glass fibrous material, carbon fibrous material, or aramid fibrous material are between about 10 g/m² up to approximately 150 g/m². From this range, it is clear that these materials are lightweight. Thus, these materials are unsuitable for use as a reinforcement fibrous material for most applications. The weight ranges for the polyester or nylon fabric varies between 20 g/m² up to 100 g/m². Again, this weight range means that the material is unsuitable for applications as a reinforcement material.

Although we do not wish to be bound by any theory, we believe that the defect free surface of the surface material is achieved by two distinct mechanisms. Firstly, the lightweight dry or semi-impregnated surface fibrous material on the surface of the surface resin film provides a highly porous medium for the extraction of any trapped air at the tool surface. This enables the surface fibrous material to be completely wetted out during processing, whereby the surface fibrous material is wetted from the resin core of the surface material towards the mold surface. This mechanism was discussed above. Secondly, the lightweight reinforcement material at the surface also holds the surface resin material in place during curing and processing, which prevents reticulation on the release coated tool surface. This prevents de-wetting and, therefore, greatly enhances the cosmetic quality surface finish.

The surface resin material can either be of a homogenous or a non-homogenous nature. The resin material can further be toughened, pigmented, or filled to suit the final required properties. Non-homogenous surface resin materials can consist of two films with distinctly different glass transition temperatures. This enables the resin materials to dissipate thermal stresses which would otherwise build up at elevated temperatures as a result of differing coefficients of thermal expansion in the laminate. The surface material may be applied as a molding material in a laminate structure.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a diagrammatic cross-sectional view of a surface material according to a first embodiment of the invention.

FIG. 2 is a diagrammatic cross-sectional view of a surface material according to a second embodiment of the invention;

FIG. 3 is a diagrammatic cross-sectional view of a surface material according to a third embodiment of the invention

FIG. 4 is a diagrammatic cross-sectional view of a surface material according to a fourth embodiment of the invention.

FIG. 5 is a diagrammatic cross-sectional view of a surface material according to a fifth embodiment of the invention.

### DETAILED DESCRIPTION OF THE PREFERRED EMBODIMENTS

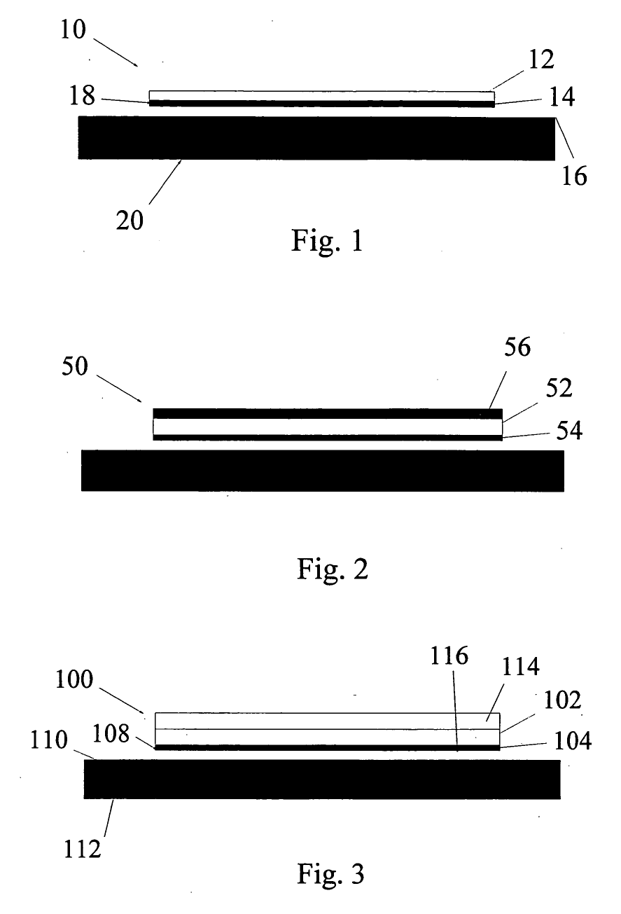

Referring to the first embodiment of the invention illustrated in FIG. 1, the surface material 10 is adapted to provide an in-mold surface coating and comprises a layer of a surface resin material 12 and a resin conducting layer 14. The resin conducting layer 14 comprises a venting structure for venting gases during processing of the surface material 10. The resin conducting layer 14 further comprises a resin retention structure 18 for keeping the resin material 12 in contact with a mold surface 16 of a mold 20. The resin conducting layer 14 comprises a fabric material which is of a lightweight structure and is woven into a fine weave.

In use, the surface material 10 is arranged inside the mold 20, whereby the resin conducting layer 14 is in contact with the mold 20. Further molding material layers may be located onto the surface material 10 to create a laminate structure. The laminate structure is then processed and cured by applying pressure and/or vacuum and increasing the temperature. With the increase in temperature, the surface resin material starts to flow (flow point), whereby the resin conducting layer 14 is fully wetted. Upon curing of the laminate structure, a molding is obtained with a high quality cosmetic surface.

Referring to the second embodiment of the invention illustrated in FIG. 2, the surface material 50 is adapted to provide an in-mold surface coating and comprises a layer of a surface resin material 52 and a resin conducting layer 54 similar to the embodiment illustrated in FIG. 1. The material 50 further comprises a fibrous reinforcement layer 56. This material 56 comprises a venting structure, which aids to vent any entrapped interlaminar and intralaminar during processing of the surface material 50. The material 56 is of a lightweight structure and preferably comprises a fine weave, which enables the surface resin to completely wet out this material 56 during processing.

In use, the surface material 50 is processed in a similar fashion to the material 10 of FIG. 1, whereby intralaminar gases which may be present between further molding layers (not shown) provided onto the surface material 50 and the surface material 50 can be vented via layer 56. Upon curing of the laminate structure, a molding is obtained with a high quality cosmetic surface.

Referring to the third embodiment illustrated in FIG. 3, the surface material 100 is also adapted to provide an in-mold surface coating. The surface material 100 comprises a layer of a surface resin material 102 and a resin conducting layer 104. The resin conducting layer 104 comprises a venting structure for venting interlaminar and intralaminar gases during processing of said surface material 100, said resin conducting layer 104 further comprising a resin retention structure 108 for keeping said resin material 102 into contact with the surface 110 of a mold 112. The surface material 100 further comprises a layer of a reinforcement resin material 114 which is located onto the surface resin material 100. The surface resin material 102 comprises a lower glass transition temperature (T_{g}) than the glass transition temperature T_{g} of the reinforcement resin material 114. This has the advantage that the resin retaining structure 108 can be fully wetted out during processing before the reinforcement resin 114 starts to flow with an increase in processing temperature. Also, the cure of the surface resin material 102 starts sooner and at a lower temperature, whereby the minimum viscosity of the surface resin material 102 is higher than the minimum viscosity of the reinforcement resin material 114. This prevents intermixing of the surface resin 102 and the reinforcement resin 114 at the external surface of the surface material 100, which could otherwise result in surface defects.

In use, the surface material 100 is arranged inside the mold 112, whereby the resin retention structure 104 is in contact with the mold surface 110. Further molding material layers may be located onto the surface material 100 to create a laminate structure. The laminate structure is then again processed and cured by applying pressure and/or vacuum and increasing the temperature. With the increase in temperature, the surface resin material starts to flow, whereby the resin conducting layer 108 is fully wetted. The reinforcement resin material 114 and the surface resin material 102 are prevented from intermixing at the external surface 116 of the surface material due to the difference in glass transition temperatures of the materials and the difference in viscosity profiles of the materials during processing. Upon curing of the laminate structure, a molding is obtained with a high quality cosmetic surface.

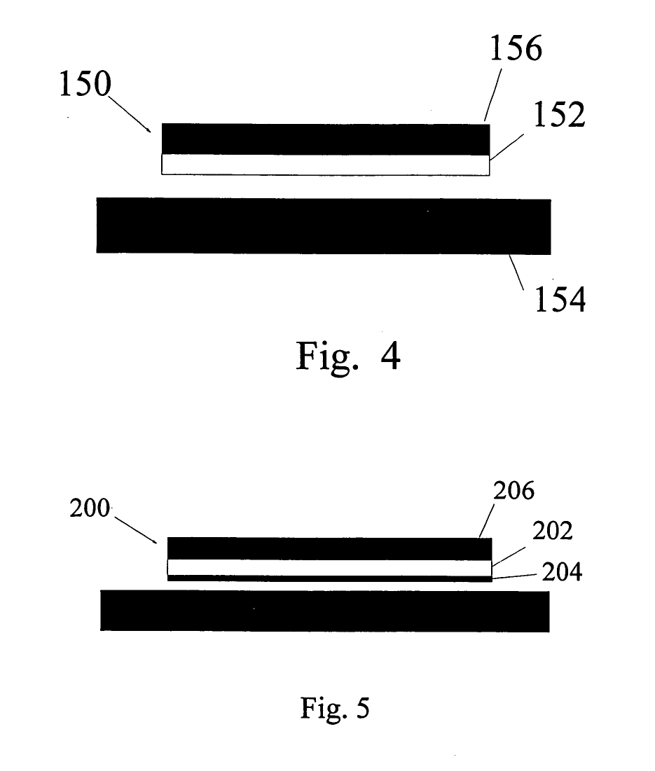

Referring to the fourth embodiment of the invention illustrated in FIG. 4, the surface material 150 is also adapted to provide an in-mold surface coating. The surface material 150 comprises a layer of a surface resin material 152 and a resin conducting layer 156. The resin conducting layer 156 comprises a venting structure for venting cases during processing of the surface material 150. The resin conducting layer 156 further provides a resin retention structure for retaining the surface resin material 152 into contact with a mold surface 154 during processing of the material 150. The resin conducting layer 156 is adapted to move through the surface resin layer 152 during processing of the material 150 so as to provide a venting structure within the surface resin material to allow gases that are entrapped between the mold surface and the surface material to escape. The resin conducting layer further allows entrapped interlaminar and intralaminar gases to escape. The structure of the resin conducting layer 156 is adapted to reduce the tendency for the formation of surface irregularities such as de-wetting during processing.

In use, the surface material 150 is processed in two stages. Under ambient temperature and pressure (vacuum pressure), the resin conducting layer 156 is forced through the high viscosity surface resin film 152 to provide a path for entrapped gases to be removed through the surface film thickness. The resin conducting layer 156 is thick and resilient enough to withstand the application of a vacuum pressure and is pushed through the resin film 152. After this stage, the temperature is raised, the resin 152 viscosity drops, and the resin flows into the resin conducting layer, aided by the vacuum pressure, to provide a smooth surface finish and to fill the resin conducting layer 156 with resin 152.

Finally, referring to the fifth embodiment illustrated in FIG. 5, the surface material 200 is also adapted to provide an in-mold surface coating. The surface material 200 comprises a layer of a surface resin material 202 and a first resin conducting layer 204. The first resin conducting layer 204 comprises a venting structure for venting cases during processing of the surface material 200. The first resin conducting layer 204 further provides a resin retention structure for retaining the surface resin material 202 into contact with a mold surface during processing of the material 200. The surface material 200 further comprises a second resin conducting layer 206, which is adapted to move through the surface resin layer 202 during processing of the material 200 so as to provide a venting structure within the surface resin material to allow entrapped gases to escape. The gases may be trapped between the mold surface and the surface material 200 and/or the gases may comprise entrapped interlaminar and intralaminar gases. The structure of the first resin conducting layer 204 is adapted to reduce the tendency for the formation of surface irregularities, such as de-wetting, during processing, whereas the second resin conducting layer 206 is adapted to conduct entrapped gases out of the surface material.

In use, the surface material 200 is processed in two stages. Under ambient temperature and pressure (vacuum pressure), the second resin conducting layer 206 is forced through the high viscosity surface resin film 202 to provide a path for entrapped gases to be removed through the surface film thickness. The second resin conducting layer 206 is thick and resilient enough to withstand the application of a vacuum pressure. Entrapped gases between the mold surface and the surface material 200 and laminar gases escape via the first and second resin conducting layers 204, 206. After this stage, the temperature is raised, the resin 202 viscosity drops, and the resin 202 flows into the first and second resin conducting layers 204, 206 aided by the vacuum pressure, to provide a smooth surface finish and to fill the resin conducting layers 204,206 with resin 202. The resin retention structure of the first resin conducting layer 204 prevents surface irregularities such as de-wetting.

The surface materials 10,50,100,150,200 are each adapted to be processed separately or as part of a laminate structure comprising the surface material 10,50,100,150,200 and one or more molding material layers.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A surface material adapted to provide an in-mold surface coating for use with a molding material, the surface material comprising:
a layer of a surface resin material; and
a resin conducting layer, said resin conducting layer comprising a venting structure for venting gases during processing of said surface material, said resin conducting layer further providing a resin retention structure for retaining said surface resin material in contact with the mold surface during processing of said surface material, wherein the resin conducting layer comprises a woven or non-woven thermo-plastic fabric material.

2. A surface material according to claim 1 wherein the thermoplastic fabric material has a weight of between 20 g/m² up to 100 g/m².

3. A preform surface material adapted to provide an in-mold surface coating for use with multiple layers of a preform molding material, said perform molding material comprising a reinforcement resin material, the surface material comprising:
a layer of a surface resin material and a resin conducting layer, said resin conducting layer comprising a venting structure for venting gases during processing of said surface material, said resin conducting layer further providing a resin retention structure for retaining said surface resin material in contact with the mold surface during processing of said surface material; and
wherein, during processing of the surface material, the minimum viscosity of the surface resin material is higher than the minimum viscosity of the reinforcement resin material to retain the surface resin material on the mold surface.

4. A surface material according to claim 3 wherein the resin retention structure has a fine weave or the like structure to reduce the tendency for the formation of surface irregularities.

5. A surface material according to claim 3 wherein the resin conducting layer is adapted to move through the surface resin material during processing of the surface material to provide a gas venting route in a direction approximately perpendicular to the mold surface.

6. A surface material according to claim 3 wherein the thickness of the resin conducting layer is larger than the thickness of the surface resin layer.

7. A surface material according to claim 3 wherein the material further comprises a further resin conducting layer, the further resin conducting layer comprising a venting structure for venting gases during processing of the material.

8. A surface material according to claim 7 wherein the further resin conducting layer is adapted to move through the surface resin layer during processing of the surface material.

9. A surface material according to claim 3 wherein the reinforcement resin material comprises higher glass transition temperature properties than the glass transition temperature properties of the surface resin material.

10. A surface material according to claim 3 wherein the surface resin material and the reinforcement resin material comprise such thermal expansion properties that thermal stresses are dissipated in the surface material.

11. A surface material according to claim 3 wherein the surface resin material comprises a gel coat resin material.

12. A surface material according to claim 3 wherein the surface resin material is non-homogeneous so as to adapt the properties of the surface material to the properties of the molding material to avoid interfacial stresses between the molding material and the surface material.

13. A surface material according to claim 3 wherein the resin conducting layer comprises a woven or non-woven thermo-plastic fabric material.

14. A surface material according to claim 3 wherein the surface material comprises a surface reinforcement layer.

15. A surface material according to claim 14 wherein the surface reinforcement layer comprises a woven and/or non-woven fibrous surface reinforcement material.

16. A laminate structure comprising:
one or more layers of a molding material; and
one or more layers of a surface material including a layer of a surface resin material, and a resin conducting layer, said resin conducting layer comprising a venting structure for venting gases during processing of said surface material, said resin conducting layer further providing a resin retention structure for retaining said surface resin material in contact with the mold surface during processing of said surface material, wherein the resin conducting layer comprises a woven or non-woven thermo-plastic fabric material.

17. A method of forming a molded article comprising:
providing a surface material including a layer of a surface resin material, and a resin conducting layer, said resin conducting layer comprising a venting structure for venting gases during processing of said surface material, said resin conducting layer further providing a resin retention structure for retaining said surface resin material in contact with the mold surface during processing of said surface material, wherein the resin conducting layer comprises a woven or non-woven thermo-plastic fabric material;
providing the surface material in relation to a mold surface;
providing one or more layers of a molding material in relation to said surface material to form a laminate structure; and
processing said laminate structure to form said molded article.

18. A method according to claim 17 wherein the molded article is processed in two stages wherein, in the first stage, the surface resin impregnates the resin retention structure and, in the second stage, the laminate structure is processed to cure.

19. A method according to claim 18 wherein the first and the second processing stages are conducted simultaneously.

20. A method of manufacturing a surface material comprising the steps of:
providing a layer of a resin conducting material, said resin conducting layer comprising a venting structure for venting gases during processing of said surface material, said resin conducting layer further comprising a resin retention structure for retaining said resin material into contact with the mold surface during processing of said surface material;
providing a layer of a surface resin material; and
locating said layer of a surface resin material in relation to said resin conducting layer.

21. A preform surface material adapted to provide an in-mold surface coating comprising:
a layer of a surface resin material; and
a resin conducting layer, said resin conducting layer comprising a venting structure for venting gases during processing of said surface material, wherein said resin conducting layer further provides a resin retention structure for retaining said surface resin material in contact with the mold surface during processing of said surface material.

22. A preform surface material adapted to provide an in-mold surface coating comprising:
a layer of a surface resin material; and
a resin retention layer comprising a resin retention structure for retaining said resin material into contact with the mold surface during processing of said surface material and whereby the resin structure is adapted to reduce the tendency for the formation of surface irregularities during processing.
